(19) United States
(12) Patent Application Publication
(10) Pub. No.: US 2020/0160642 A1
(43) Pub. Date: May 21, 2020

(54) Device for sorting, checking and forwarding coins

(71) Applicant: Walter Hanke Mechanische Werkstatten GmbH & Co. KG, Berlin (DE)

(72) Inventor: Roland Griese, Berlin (DE)

(21) Appl. No.: 16/686,871

(22) Filed: Nov. 18, 2019

(30) Foreign Application Priority Data
Nov. 19, 2018 (DE) 18 20 7112.6

(51) Int. Cl. G07D 3/12; G07D 3/06; G07D 9/00; G07D 5/02

(52) U.S. Cl. CPC G07D 3/128; G07D 5/02; G07D 9/008; G07D 3/06

(57) ABSTRACT

This document relates to a device for sorting, checking and forwarding coins referred to as a hopper, comprising a rotatably mounted carrier disk for feeding coins from a collection receptacle and a device for forwarding coins guided on the carrier disk to a transfer device. The device for forwarding comprises a rotatable transport disk, which is disposed adjoining the carrier disk and designed to individually receive the respective coins guided on the carrier disk and to move them past a sensor unit for determining at least one parameter of the coin. The transfer device comprises a redirection system, which is designed to channel the coin onto different transport paths as a function of the at least one parameter of the coin.

The invention relates to a device for sorting, checking and forwarding coins, comprising a rotatably mounted carrier disk for transporting coins from a collection receptacle and a device for forwarding coins guided on the carrier disk to a transfer device.

What are known as hoppers are used in cash-back automated payment terminals, wherein at times as many as eight hoppers are used for a respective coin denomination. The installation space and costs of the automated terminals are reduced by a hopper for multiple coin denominations. In the case of the so-called multi coin hopper, coins are placed uncontrolled into a receiving or collection receptacle, and the coins from the collection receptacle are sorted by way of a device and forwarded to a cash register and/or a dispenser.

For example, a hopper comprising a rotating disk, which has a plurality of radially arranged coin chambers or coin recesses, is known from U.S. Pat. No. 7,628,685 B2, wherein additionally an ejection unit for feeding out the coins accommodated in the individual chambers is provided.

The automated terminal industry is striving to create disabled-friendly machines in which the coin slot and coin return are located closely together. For this purpose, the design of the hoppers has to be adapted toward the top for dispensing the coins.

Proceeding from the prior art, it is the object of the present invention to create a device for sorting, checking and forwarding coins in which coins of varying sizes and thicknesses are checked quickly and are forwarded to a sorting or dispensing unit likewise at rapid speed, wherein a variability of the design for an automated terminal using one or more hoppers is provided.

According to the invention, this object is achieved by the features of the main claim.

The measures described in the dependent claims enable advantageous refinements and enhancements.

According to the invention, the device for sorting, checking and forwarding coins is provided with a rotatably mounted carrier disk for feeding coins from a collection receptacle and a device for forwarding coins guided on the carrier disk to a transfer device, wherein the device for forwarding comprises a rotatable transport disk, which is disposed adjoining the carrier disk and designed to individually receive the respective coins guided on the carrier disk and to guide these past a sensor unit for determining at least one parameter of the coin. The transfer device comprises a redirection system, which is designed to channel the coin onto different transport paths as a function of the at least one parameter of the coin.

The device according to the invention allows coins of different types to be fed from a collection receptacle, measured and channeled onto different transport paths at great speed, wherein collisions among the coins are prevented. In the process, the coins received from the carrier disk by means of the transport disk of the device for forwarding are transported upwardly, with respect to the carrier disk, to the redirection system, which channels the coins, for example, to a dispensing system, wherein the latter can be disposed in the automated terminal in keeping with the requirements for different dispensing locations.

According to a refinement, the transport disk comprises a base plate and at least one gripper arm, which rotate together, and furthermore means for clamping the coin between the base plate and the at least one gripper arm are provided. Using the gripper arm or gripper arms, the coins can be pulled quickly from the carrier disk, wherein the means for clamping help to clamp a coin between the base plate and the at least one gripper arm, whereby the coin is transported further securely between the base plate and the gripper arm, which rotate together.

In the exemplary embodiment, the transport disk rotates synchronously with the carrier disk at a predefined speed ratio, that is, the rotational positions of the disks have to remain synchronized at all times, since otherwise the gripper arm does not grip in the correct position. According to these conditions, the speeds of the transport disk and of the carrier disk can be optimally matched to one another so as to increase the feed speed.

In one exemplary embodiment, the transport disk comprises multiple gripper arms, and the carrier disk comprises multiple carrier recesses or carrier chambers in which the sorted coins are accommodated, wherein the number of the gripper arms and the number of the carrier chambers have a fixed ratio to one another. In this way, the speed of the carrier disk and the speed of the transport disk can furthermore be optimized with respect to one another, whereby a collision of the coins, or the coins passing one another, can be avoided, despite the fast pace. A ratio of 3:1 was preferably selected, which is based on empirical values. However, the carrier disk should also not rotate too quickly. The coins need time to reach the coin chambers. Moreover, the coins need time to be sorted, wherein sorting starts with the nine o'clock position of the carrier disk. This cannot be ensured by a carrier disk that rotates too quickly. In addition, a carrier disk that is not filled at all times also decreases the pace. Other ratios are conceivable, but should be selected as a function of the diameter of the carrier disk.

According to one exemplary embodiment, the means for clamping the coins comprise a guiding segment, which is fixed relative to the at least one rotating gripper arm, for raising and lowering the at least one gripper arm. By providing such a guiding segment, a coin can be clamped more easily and more cost-effectively between the gripper arm and the base plate of the transport disk. The guiding segment has a planar section and two chamfers on each end of the planar section, whereby the gripper is easily raised on the one end of the guiding segment, glides on the planar guiding segment in a raised position, and is lowered again on the chamfer at the end of the guiding segment.

In one exemplary embodiment, the means for clamping comprise at least one gliding pin, which is assigned to the at least one gripper arm and designed to glide on the guiding segment. As a result of the cooperation between the guiding segment and the gliding pin, a simple mechanical solution for raising and lowering the gripper arm is provided. As a result of this measure, furthermore secure and low-friction guidance can be achieved between the at least one gripper arm and the guiding segment.

Preferably, a spring is assigned to the at least one gripper arm, which is designed and disposed to be compressed when the gripper arm is raised, and to relax during lowering. Such a spring supports rapid and secure lowering of the gripper arm.

In one exemplary embodiment, the at least one gripper arm comprises a clamping surface in the form of a flat tip for bearing against a coin to be transported. This tip is very flat and is selected to be made of a soft material, such as fluoro rubber having a predefined Shore hardness of 80, for example, so as to grip the coin in a punctual manner and to conform in a more areal manner by way of the spring contact. This also compensates for more pronounced relief depths on the coin. The clamping surface should have sufficient grip to prevent the coin from slipping. In this way, the coin can be clamped and transported securely between the gripper arm and the base surface.

In a particularly advantageous manner, the transfer device comprises an ejection lever having a snap-action system, wherein projections for triggering the snap-action system and actuating the ejection lever are disposed on the transport disk. By providing the ejection lever with the snap-action system, the coin is fed securely and quickly into the redirection system when the snap-action system is triggered.

In one exemplary embodiment, the sensor unit is fixed beneath the base plate of the transport disk and is designed to establish the coin size and at least one material property. As a result of this arrangement, the coin can already be distinguished in terms of the type thereof as the coin travels on the transport disk, and can be accordingly processed in the redirection system. This measure increases the speed of feeding and identifying the coin.

In one exemplary embodiment, the redirection system comprises a flap system, which can be controlled as a function of the at least one parameter of the coin. As a result of the flap system, which can be pivoted into the path of the coin, the coin can be channeled onto different paths upon actuation of the ejection lever, such as forwarded for dispensing or forwarded to a main cash register or returned into the collection receptacle.

The drawings shows an exemplary embodiment, which will be described in greater detail hereafter. In the drawings:

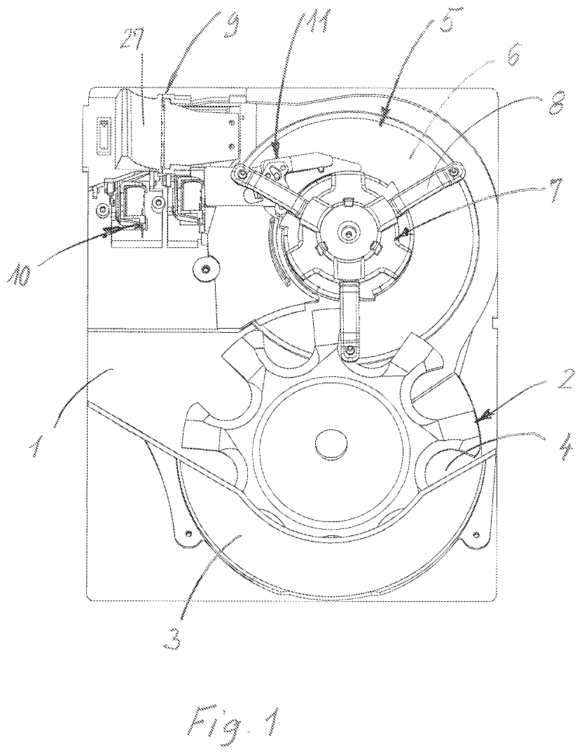

FIG. 1 shows a front view of an exemplary embodiment of the device according to the invention;

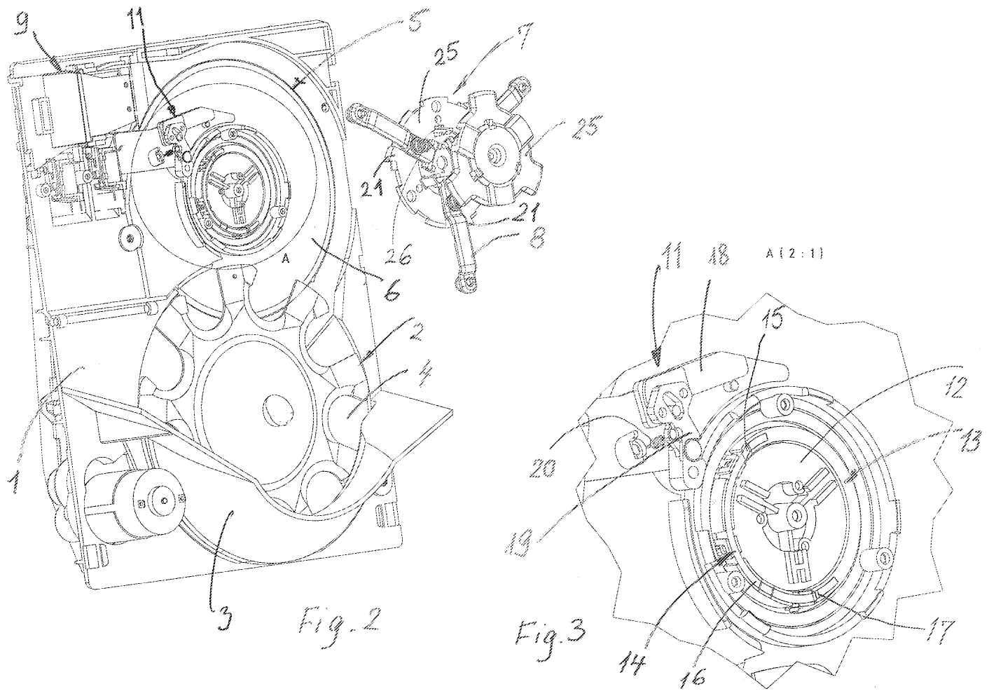

FIG. 2 shows a perspective view of the device according to the invention from FIG. 1, in which the gripper arms are shown in a separate illustration;

FIG. 3 shows an enlarged illustration of the central region of the transport disk used in the exemplary embodiment according to FIG. 1 and FIG. 2;

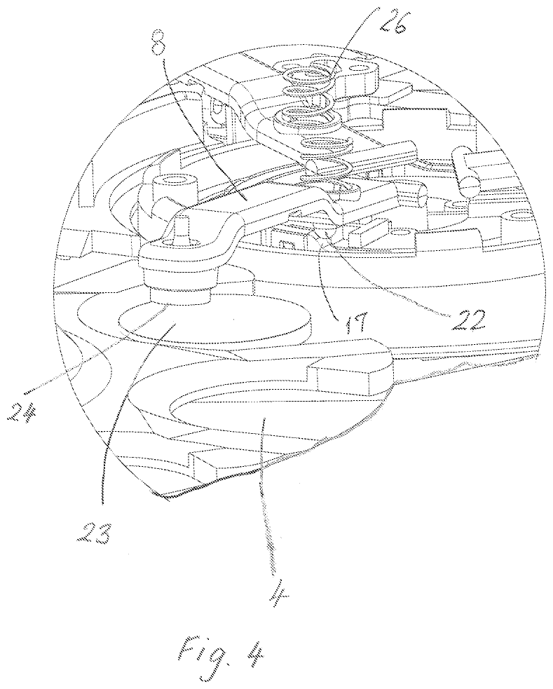

FIG. 4 shows a perspective view of a section of the carrier disk and of the transport disk with a raised gripper arm;

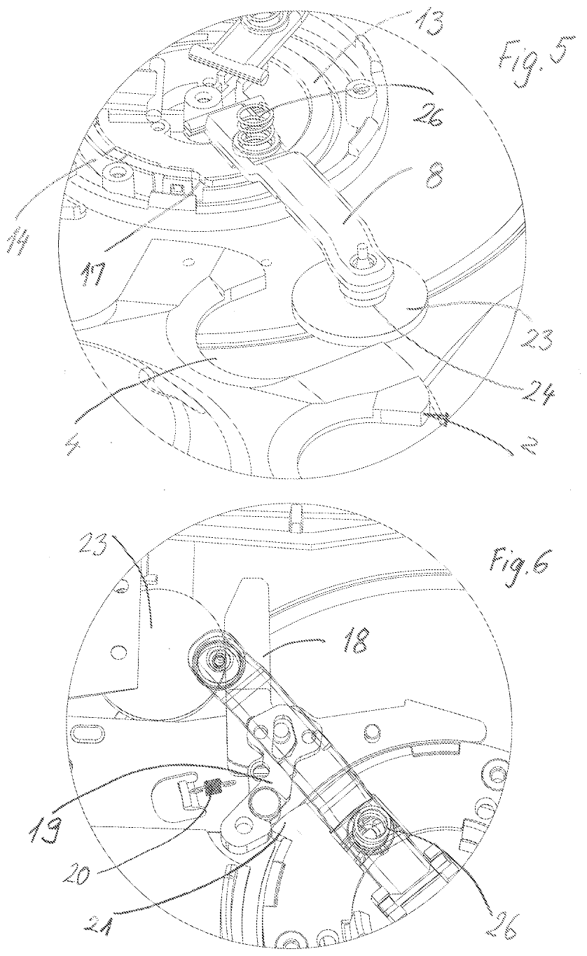

FIG. 5 shows a perspective view of FIG. 4, in which the gripper arm has received a coin; and

FIG. 6 shows a top view onto a section of the device according to the invention in which a coin guided on the transport disk is channeled into the redirection unit.

FIG. 1 shows the front view of an exemplary embodiment of a device according to the invention for sorting, checking and forwarding coins, which is usually referred to as a hopper. The device comprises a carrier disk 2 attached on a plate 1, wherein a collection receptacle, which is not shown and provided with a guide plate shown in FIG. 1 and denoted as a funnel 3, is disposed above the carrier disk 2 for partially covering the same. During operation, a plurality of coins of different denominations, but usually of one type or currency, such as euro coins, are present in the collection receptacle and on the funnel 3. Distributed across the circumferential region thereof, the carrier disk 2 is provided with a plurality of carrier chambers 4, which are formed by recesses 4 incorporated in the carrier disk 2 proceeding from the circumference. The coins accommodated in the collection receptacle, which is not shown, may come in contact with the carrier disk 2, which is rotatably mounted in the plate 1 and driven by way of a drive including a gearbox for rotation about a central axis. Coins, which are randomly accommodated in the collection receptacle in an unsorted manner, are carried along in the individual chambers or recesses 4 during a rotation of the carrier disk 2 by way of the carrier chambers or recesses 4, and, as a result of the rotational movement of the carrier disk 2, are transported upwardly away from the lower region of the collection receptacle. In the installed position, in which the device is installed in an automated terminal, the plate 1 is disposed at a predefined angle obliquely with respect to the vertical, so that this may be referred to as the coins being transported from the bottom to the top.

A transport disk 5, which comprises a base plate 6 and a gripper arm part 7, is disposed above the carrier disk 2 and partially therebeneath. The gripper arm part 7 and the base plate 6 are connected to one another so as to rotate joint-ly about a central axis. The transport disk 5 or the gripper arm part 7 comprises three gripper arms 8, which are disposed at regular angular spacing with respect to one another. The length of the gripper arms 8 is such that the gripper arms essentially extend to the circumference of the base plate 6 of the transport disk 5.

Similarly to the carrier disk 2, the transport disk 5 is also driven by the drive, which is not shown, so as to rotate. A rigid connection, which is designed as a gear wheel connection in the exemplary embodiment, exists between the two disks 2, 5, wherein a toothed belt connection would also be conceivable. The rotational positions of the disks have to remain synchronized at all times, since otherwise the gripper arm does not grip in the correct position. The carrier disk 2 and the transport disk 5 rotate synchronously with respect to one another, but at different speeds, that is, the rotational positions of the disks 5, 7 have to remain synchronized at all times. In the present case, the transport disk 5 has three times the speed of the carrier disk 2, that is, the ratio of the speed of the transport disk to that of the carrier disk is 3:1, and the number of gripper arms 8 of the transport disk 5 is three, while the carrier disk 2 comprises nine carrier chambers 4.

A redirection system, which is designed as a flap part 9 and channels a supplied coin into different coin channels or shafts or paths, is provided next to the upper region of the transport disk 5. The flap part 9 is controlled by a relay system 10, which comprises pivoting armature magnets.

Finally, an ejector unit 11 is disposed on a part that is fixed with respect to the transport disk 5, likewise in the upper region of the transport disk 5 between the gripper arm part 7 and the flap part 9, the ejector unit, as will be described later, feeding a coin that is guided between a gripper arm 8 and the base plate 6 into the flap part 9 by way of an ejection motion.

FIG. 2 shows a perspective view corresponding to FIG. 1, in which the gripper arm part 7 is represented separately from the system in an exploded view, and FIG. 3 shows an enlarged illustration of the central region of the transport disk 5 surrounded by a circle, in which the gripper arm part 7 has been removed.

A rotatable shaft part 12, to which the gripper arm part 7 is attached and which rotates together with the base plate 6 of the transport disk 5, is disposed in the central region of the transport disk 5. The shaft part 12 of the central region of the transport disk 5 is surrounded by a stationary guiding part 13, which includes a guiding segment 14. The guiding segment 14 extends approximately across half the circumference of the shaft part and is provided with a raising chamfer 15, a planar section 16 and a lowering chamfer 17, on which the gliding arms 8 are guided. The raising chamfer 15, the planar section 16 and the lowering chamfer 17 are preferably covered with a material or are composed of a material having low friction.

On the right side of FIG. 3, beneath the base plate, a measuring system comprising a sensor system is disposed, which is designed to detect different parameters of a coin, such as the size or diameter and the material of the coin. The sensor system can comprise a coil having a ferrite core.

Moreover, the ejection unit 11 is apparent in greater detail in FIG. 3, which comprises the ejector lever 18, a snap-action lever 19 and a return spring 20.

As stated, the gripper arm part 7 is rigidly connected to the shaft part 12. The gripper arm part 7 according to FIG. 2 comprises three gripper arms 8, which are accommodated between two retaining plates 25. Projections 21, which are used to trigger the ejection unit 11 or the snap-action system of the ejection unit 11, are provided on the circumference of one of the retaining plates 25, which is the lower one in FIG. 2. Since three gripper arms 8 are provided, three trigger projections 21 are also provided.

The operating principle of the device according to the invention will be described in greater detail based on FIGS. 4, 5, 6 showing details of the device.

During operation, the carrier disk 2 rotates and feeds coins from the collection receptacle, which are guided out of the bulk of coins by way of the carrier chambers 4 of the carrier disk 2 and transported upwardly in the carrier chambers 4 in accordance with FIGS. 1 and 2. In the embodiment, the carrier disk 2 comprises nine carrier chambers 4 and rotates at a predefined speed. The transport disk 5, on which three gripper arms 8 are provided, rotates synchronously thereto, wherein in the exemplary embodiment the transport disk 5 rotates at three times the speed of the carrier disk 2.

Each of the gripper arms 8 comprises a spring-loaded gliding pin 22 (see FIG. 4), which glides on the guiding segment 14. The respective gripper arm 8 is raised when the associated gliding pin 22 moves across the raising chamfer 15, the arm 8 is moved further in the raised state, in which the gliding pin 22 glides on the planar section 16, and, on the lowering chamfer 17, the spring 26 assigned to the gliding pin 22 pushes the pin 22 down, wherein the pin is without contact with the fixed guiding part 13 in the region outside the guiding segment 14. In FIGS. 4 to 6, the spring 26 is shown in the relaxed state since the retaining plates 25, which fix the gripper arms 8, are not shown.

In FIG. 4, a position is apparent in which the gripper arm 8 is almost in front of the lowering chamfer 17 over a coin 23 to be gripped, which is accommodated in the carrier chamber 4. The gripper arm 8 is provided with a contact surface 24 including a flat tip, which is made of a soft material, such as fluoro rubber, which provides a certain level of friction between the coin 23 and the contact surface 24 to the effect that the coin 23 is carried along by the contact surface 24. The soft material of the contact surface conforms to the surface of the coin 23, having a relief depth that may differ as a function of the coin denomination.

Few angular degrees past the position shown in FIG. 4, the gripper arm springs back to the location of the lower carrier disk 2. If, as is the case in FIG. 4, a coin 23 is present, the gripper arm 8 pushes with the contact surface 24 thereof onto the coin 23, and since the transport disk 5 rotates three times faster than the carrier disk 2, the gripper arm 8 pulls the coin 23 out of the carrier chamber 4 of the carrier disk 2. The coin is then located almost in front of the measuring system, which is not shown and located beneath the transport disk 5, and may be measured with respect to the size thereof and/or other properties thereof. For example, since it is possible to feed twelve coins per second by way of the transport disk 5, the described steps are carried out in rapid succession.

FIG. 5 shows the coin being pulled out of the carrier chamber 4 of the carrier disk 2. When a coin 23 is being pulled out of the coin recess 4, the measurement of the coin 23 is started by the sensor system located beneath the transport disk 5 at approximately the four o'clock position, as seen on a clock face. At two o'clock position, the coin 23 has been measured, and a control unit comprising a processor decides what is to be done with this coin 23.

The coin 23 is now transported upwardly until it reaches the region of the ejection unit 11, in which the gripper arm is about to reach the raising chamfer 15 of the guiding segment 14 so as to release the coin 23. The coin 23 has already been measured, and it has been decided where it will be forwarded to. The gripper arm 8 is raised as a result of the raising chamfer 15 and releases the coin 23, wherein it rests on the straight part of the ejection lever 18, which is still in the idle position. The ejection lever 18 is then actuated by the projection 21 on the gripper arm part 7 assigned to the gripper arm 8 and springs forward or upward, as is shown in FIG. 6 (the gripper arm 8 is shown “transparent” in the figure). The projection 21 runs along the snap-action lever 19 and triggers the snap-action device, as a result of which the coin 23 experiences a knock. The return spring 20 then brings the ejection unit 11 back into the starting position thereof.

The redirection system 9 comprises a flap part, which is moved into different positions by the relay system 10 as a function of the measured parameters of the coin and additional payment conditions, whereby the pushed-in coin 23 can be channeled onto different paths. For example, the coin 23 may be guided via a coin channel, in which a light barrier for acknowledgment is disposed, to a main cash register. In most instances, however, the coin 23 is to be dispensed. The first pivoting armature magnet then receives the signal from the control unit and opens a flap, which exposes the path for dispensing. As soon as the coin 23 enters a first light barrier located directly on the flap opening, the flap is returned by way of a compression spring after a few milliseconds and acknowledged at the exit with a further light barrier. Finally, the flap system is also designed such that, on a deflection surface 27 facing the observer, for example in FIG. 1, a coin 23 drops back into the collection receptacle, wherein it reaches the funnel 3 and is returned into the plurality of coins in the collection receptacle.

The signals of the different light barriers are transmitted to the control unit, which is not shown and which accordingly controls the flap system 9 and the measures for forwarding the coins.

1. A device for sorting, checking and forwarding coins, comprising a rotatably mounted carrier disk for feeding coins from a collection receptacle and a device for forwarding coins guided on the carrier disk to a transfer device, wherein the device for forwarding comprises a rotatable transport disk, which is disposed adjoining the carrier disk and is configured to individually receive the respective coins guided on the carrier disk and to guide these past a sensor unit for determining at least one parameter of the coin, and wherein the transfer device comprises a redirection system, which is configured to channel the coin onto different transport paths as a function of the at least one parameter of the coin.

2. The device according to claim 1, wherein the transport disk comprises a base plate and at least one gripper arm, which are rotated together, and comprising means for clamping the coin between the base plate and the at least one gripper arm.

3. The device according to claim 1, wherein the transport disk rotates synchronously with the carrier disk at a predefined speed ratio.

4. The device according to claim 3, wherein the transport disk comprises a plurality of gripper arms, the speed ratio being dependent on the number of the gripper arms.

5. The device according to claim 1, wherein the transport disk comprises a plurality of gripper arms, and the carrier disk comprises a plurality of carrier recesses for accommodating the coins, the number of the gripper arms and the number of the carrier recesses have a fixed ratio to one another.

6. The device according to claim 2, wherein the means for clamping the coin comprise a guiding segment, which is fixed relative to the at least one rotating gripper arm, for raising and lowering the at least one gripper arm.

7. The device according to claim 6, wherein the guiding segment includes a planar section and two chamfers.

8. The device according to claim 6, wherein the means for clamping comprising at least one gliding pin, which is assigned to the at least one gripper arm and configured to glide on the guiding segment.

9. The device according to claim 8, wherein a spring is assigned to the at least one gripper arm, which is arranged to be compressed when the gripper arm is raised, and to relax during lowering.

10. The device according to claim 2, wherein the at least one gripper arm includes a clamping surface for bearing against a coin to be transported.

11. The device according to claim 1, wherein the transfer device comprises an ejection lever having a snap-action system, projections being provided on the transport disk for triggering the snap-action system and actuating the ejection lever.

12. The device according to claim 1, wherein the sensor unit is fixed beneath the base plate of the transport disk and configured to establish the coin size and at least one material property.

13. The device according to claim 1, wherein the redirection system comprises a flap system, which is configured to be controlled as a function of the at least one parameter of the coin.

14. The device according to claim 10, wherein the clamping surface includes a conformable material configured to conform to a relief depth of the transported coin.

15. The device according claim 1, wherein the carrier disk and the transport disk are configured to be driven by a drive so as to rotate, the drive providing a rigid connection between the carrier disk and the transport disk.
